(19) United States
(12) Patent Application Publication
(10) Pub. No.: US 2024/0362354 A1
(43) Pub. Date: Oct. 31, 2024

(54) NATIVE DATABASE TENANT LIFECYCLE MANAGEMENT

(71) Applicant: SAP SE, Walldorf (DE)

(72) Inventors: Hyunjun KIM, Seoul (KR); Patrick VOELKER, Mannheim (DE); Urs KLINGSPORN, Waldorf (DE); Yong Sik KWON, Seoul (KR); Jaeyoung CHOI, Seoul (KR); Myunggon PARK, Seoul (KR); Yeonghun JEONG, Seoul (KR); Yong Wook JEONG, Seoul (KR); Chawon KO, Seoul (KR); Yin LONG, Shanghai (CN); Mihnea ANDREI, Issy les Moulineaus (FR)

(21) Appl. No.: 18/307,244

(22) Filed: Apr. 26, 2023

(51) Int. Cl. G06F 21/62; G06F 21/60

(52) U.S. Cl. CPC G06F 21/6227; G06F 21/604; G06F 2221/2141

(57) ABSTRACT

Systems and methods include reception of a call to an application programming interface, the call comprising a request to create a database tenant in a database instance executing on a database platform, determination, at an operator executing on the database platform, to create the tenant based on the received call, retrieval, in response to the determination, by the operator of credentials of a tenant manager user from a storage external to the database platform, connection of the operator to the database instance using the credentials, transmission, from the operator to the database instance, of a Structured Query Language command to create the tenant and, in response to the command, creation of the tenant in the database instance.

### BACKGROUND

Multi-tenancy is a software architecture pattern which facilitates the sharing of computing resources among disparate groups of users. For example, a single multi-tenant application (e.g., a Software-as-a-Service (SaaS) application) may serve multiple end user groups (i.e., customers) within a single software instance. Such a software instance uses a much smaller computing resource footprint than would be required to provision one software instance per customer. Multi-tenancy can therefore provide substantial cost benefits.

The data of each customer in a multi-tenant architecture is typically mapped to a corresponding tenant in the underlying data layer. This mapping allows for logical separation of the data within the data layer and facilitates access thereto by the multi-tenant application. In some multi-tenant architectures, the data of each tenant is managed by a different database instance executing within the same computing system (e.g., a rack server). These architectures provide good separation of tenant data, but it may be cost-inefficient in some scenarios to require a full database instance per tenant. For example, the smallest database instance may consume 32 Gb of memory, which may represent significantly more computing resources than would otherwise be required by a small tenant.

Other multi-tenant architectures use a single database instance to manage the data of multiple tenants. Multi-tenant architectures that use a single database instance to manage the data of multiple tenants allow the sharing of resources (e.g., processor cycles, memory) between tenants while maintaining tenant-specific data isolation. Since the data in such an architecture is not physically separated, the multi-tenant application is responsible for tracking and managing the data in a tenant-aware manner. For example, a database system may use one schema of a single instance for all tenants, where the data of each tenant is partitioned via a discriminating column. The multi-tenant application uses the values of the discriminating column to identify the data belonging to specific tenants. In another example, the multi-tenant application assigns a dedicated schema to each tenant. In either case, the database system is unaware of the existence of the multiple tenants and operates in the same manner as if it were being accessed by a single-tenant application.

Recent database systems provide native multi-tenancy via a database-level tenant object (e.g., a database catalog object) which facilitates the implementation of multi-tenant architectures on the application layer. A native multi-tenant database system may include one or more database instances, the data of all tenants, and engines for processing the data. The single system also includes a single persistence to store the data of all the tenants. By allowing multiple, independent tenants, or rather customers, to be hosted on a single instance and share computing resources, deployment of a new tenant to a database instance is associated with a near-zero marginal cost.

The tenant object is a logical collection of data and metadata artifacts which have been assigned to a tenant. Tenants may be exposed as first-class database objects (i.e., having an identity independent of any other database entity). It is desirable to allow select users to initiate tenant lifecycle management operations (e.g., create tenant, delete tenant and update tenant) in a secure manner which does not expose the corresponding Data Description Language (DDL) statements, while also allowing other users to assign artifacts to existing tenants.

### BRIEF DESCRIPTION OF THE DRAWINGS

FIG. 1 is a block diagram of a database system providing native multi-tenancy and according to some embodiments.

FIG. 2 illustrates an architecture for tenant lifecycle management according to some embodiments.

FIG. 3 comprises a flow diagram of a process to create a tenant according to some embodiments.

FIG. 4 illustrates a custom resource-based architecture for tenant lifecycle management according to some embodiments.

FIG. 5 illustrates a custom resource-based architecture for tenant lifecycle management using customer-controlled encryption keys according to some embodiments.

FIGS. 6A and 6B comprise a flow diagram of a process to create a tenant using customer-controlled encryption keys according to some embodiments.

FIG. 7 is a block diagram of a cloud-based cluster architecture according to some embodiments.

### DETAILED DESCRIPTION

The following description is provided to enable any person in the art to make and use the described embodiments. Various modifications, however, will be readily-apparent to those in the art.

Embodiments provide tenant lifecycle management operations within a database instance to a customer while preventing the customer from performing such operations directly via DDL statements sent to the database instance. Users may communicate directly with the database instance to assign artifacts to existing tenants.

According to some embodiments, a customer user does not possess database privileges to perform tenant lifecycle management operations. These privileges are granted to an internal user and an operator uses the internal user to create/delete/update tenants on behalf of the customer. A customer request to perform a tenant lifecycle management operation is transmitted to a REST API server which blocks unauthorized customers and initiates a process in which the operator executes the requested tenant lifecycle management operation.

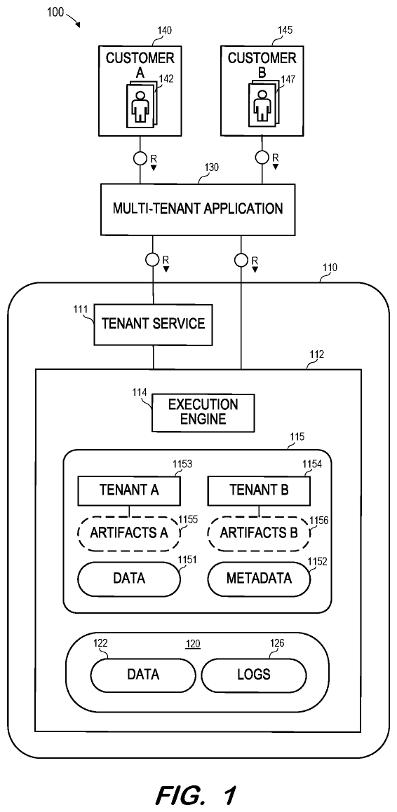

FIG. 1 is a block diagram of system 100 according to some embodiments. The illustrated elements of system 100 and of all other architectures depicted herein may be implemented using any suitable combination of computing hardware and/or processor-executable program code that is or becomes known. Such combinations may include one or more programmable processors (microprocessors, central processing units, microprocessor cores, execution threads), one or more non-transitory electronic storage media, and processor-executable program code. In some embodiments, two or more elements of system 100 are implemented by a single computing device, and/or two or more elements of system 100 are co-located. One or more elements of system 100 may be implemented as a cloud service (e.g., Software-as-a-Service, Platform-as-a-Service) using cloud-based resources, and/or other systems which apportion computing resources elastically according to demand, need, price, and/or any other metric.

Database platform 110 provides infrastructure for creating, managing and using native multi-tenant database instances. Database instance 112 provides native multi-tenancy according to some embodiments. Database instance 112 may be provisioned on any suitable combination of hardware and software, including one or more computer servers or virtual machines. In some embodiments, database instance 112 comprises a containerized application executing within a software container. Such containers may be implemented by one or more nodes of a cluster (e.g., a Kubernetes cluster) as is known in the art and will be described below.

Database instance 112 includes execution engine 114 for responding to client queries based on data and metadata stored in volatile (e.g., Random Access) memory 115. Memory 115 includes data 1151 and metadata 1152 of all tenants created within database instance 112. Data 1151 may include row store tables, column store tables, and system tables. As is known in the art, the data of each row of a row store table is stored in contiguous memory locations of memory 115, and the data of columns of column store tables is stored in contiguous memory locations of memory 115. The system tables may store metadata defining a database catalog, users, etc. Memory 115 also stores program code and stack, and memory required for temporary computations and database management.

Multi-tenant application 130 may comprise a SaaS application but embodiments are not limited thereto. Multi-tenant application 120 may be provisioned on one or more computer servers or virtual machines and may comprise a containerized application executing within a software container. Multi-tenant application 130 issues queries (e.g., SQL, MDX) to database instance 112 based on input received from users 142 and 147 of customers 140 and 145, respectively.

Database platform 110 according to some embodiments supports requests for tenant-level lifecycle operations which would otherwise need to be implemented by the application. These operations may include tenant creation, tenant drop, tenant move, tenant restore from backup, tenant clone, tenant resize and tenant resource limitation. In some embodiments, and as will be described below, shared tenant service 111 exposes APIs (e.g., via REST) which are called by multi-tenant applications (using appropriate management credentials) to request execution of these tenant-level lifecycle operations by database system instance 112.

Each tenant of system 100 will be described as corresponding to a customer, where a customer may be a company, a division, a workgroup, or any other group of users. A tenant may correspond to a particular cloud resource/service subscription of a given customer. In this regard, a customer may be associated with more than one subscription and therefore more than one tenant.

Memory 115 includes multiple instances of a tenant object defined in metadata 1152. Each tenant object instance is a collection of database artifacts, where the artifacts assigned to each tenant instance are stored within data 1151. The database artifacts assigned to a tenant instance may include, for example, one or more schemas, tables, and partitions. The database artifacts may also include metadata defining views on the tenant's tables, virtual tables, caches, remote sources, workload classes used to govern resource usage for the tenant's database objects, and database users.

Memory 115 includes tenant instance 1153 of tenant ‘A’ and tenant instance 1154 of tenant ‘B’. Each tenant instance 1153 and 1154 is an instance of a tenant object defined in metadata 1152. Tenant instances 1153 and 1154 may be stored within data 1151 but are depicted separate therefrom for ease of understanding.

Each tenant instance 1153 and 1154 is a collection of database artifacts. The artifacts assigned to each tenant instance 1153 and 1154 are stored among data 1151 and metadata 1152. Accordingly, artifacts A 1155 assigned to tenant instance 1153 and artifacts B 1156 assigned to tenant instance 1154 are depicted using dashed lines to represent references to database artifacts of data 1151 and metadata 1152. The database artifacts assigned to a tenant instance may include, for example, one or more schemas, tables, and partitions. The database artifacts may also include metadata defining views on the tenant's tables, virtual tables, and remote sources.

The lifecycle of a tenant may be decoupled from the lifecycle of its assigned database artifacts. However, in some embodiments, deleting a tenant from a database instance results in deleting artifacts assigned thereto, so long as those artifacts are not assigned to another tenant of the database instance.

It will be assumed that customer A 140 corresponds to a first tenant (e.g., tenant A 1153) of database instance 112 and that customer B 145 corresponds to a second tenant (e.g., tenant B 1154) of database instance 112. Upon receipt of input from a user 142 of customer A 140, multi-tenant application 130 may transmit a query to database instance 112 which indicates an association with the first tenant. Similarly, upon receipt of input from a user 147 of customer B 145, multi-tenant application 130 may transmit a query to database instance 112 along with an indication that the query is associated with the second tenant.

Accordingly, multi-tenant application 130 is able to determine the tenant which corresponds to a user from whom input is received. For example, each user may logon to multi-tenant application 130 using a tenant-specific subscription. Multi-tenant application 130 therefore associates a user with the tenant of the subscription under which the user has logged on. In another example, communications between users and multi-tenant application 130 may include tenant-identifying tokens.

Multi-tenant application 130 is also aware of which tenants are placed on which database instances. In this regard, multi-tenant application 130 may request provisioning of database instances on platform 110 using a suitable service thereof and creation of tenants on provisioned database instances using tenant service 111. Upon receiving input from a user associated with a given tenant, multi-tenant application 130 is thereby able to determine the database instance which includes the given tenant and to which a corresponding query should therefore be directed.

Upon receipt of a query from multi-tenant application 130, execution engine 114 processes the query using the artifacts (e.g., row store tables) which have been assigned to the particular tenant with which the query is associated. Each time a query received from an application consists of a transaction on data in memory 115, the transaction is logged as a log entry of a log segment stored within data 1151. The pre-transaction version of the data page is stored as an undo data page, and the data page as changed by the transaction is marked as “dirty”. Periodically, and as is known in the art, a savepoint is created by writing the dirty data pages and the corresponding undo data pages of data 1151 to persistent storage 120.

Persistent storage 120 includes data volume 122 for storing the data pages of the savepoint and log volume 126 for storing the log pages of the savepoint. The pages of the savepoint represent a consistent state of data 1151 of all assigned tenants. Data volume 122 may also include “snapshots”, or saved copies, of the data pages of respective savepoints.

Persistent storage 120 may be implemented using any persistent data storage system that is or becomes known, including but not limited to distributed data storage systems. Persistent storage 120 persists encrypted data of all assigned tenants.

Database instance 112 thereby provides a single data server including the data and metadata of all tenants of the database instance, engines for processing the data, and a single persistence for the data and metadata. Hosting multiple independent tenants on such a single database instance facilitates sharing of computing resources at near-zero marginal cost.

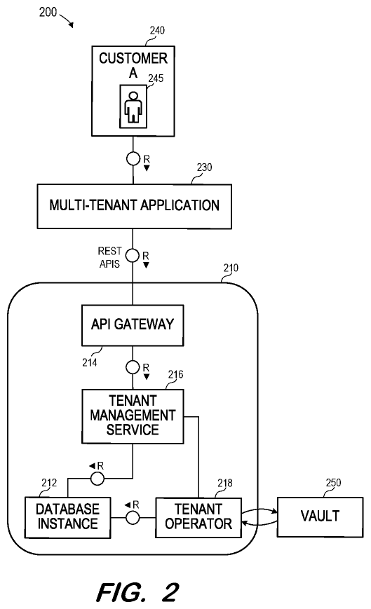

FIG. 2 is a block diagram of architecture 200 to provide tenant lifecycle operations according to some embodiments. Architecture 200 includes database platform 210 which may include the components described above with respect to database platform 110. For example, database instance 212 may include the components of and operate as described above with respect to database instance 112.

Multi-tenant application 230 calls REST APIs exposed by API gateway 214 of platform 210. The APIs are called in response to corresponding requests received from user 245 of customer 240. API gateway 214 confirms the identity of user 245 and the authority of user 245 to initiate tenant lifecycle management operations. In some embodiments, this evaluation is performed by attempting to log on to database instance 212 using credentials provided in the API call.

If confirmed, the request is forwarded to tenant management service 216. Platform 210 may include other unshown tenant-related services to which API gateway 214 forwards other incoming requests which correspond to those services.

Tenant management service 216 forwards the request to tenant operator 218. Specific mechanisms for forwarding the request from tenant management service 216 to tenant operator 218 according to some embodiments will be described below.

Tenant operator 218 issues SQL calls to database instance 212 to perform the requested tenant lifecycle management operation. Database instance 212 executes tenant lifecycle management operations only if requested under certain internal accounts. Accordingly, tenant operator 218 retrieves credentials of such an internal user account from vault 250, logs into database instance 212 using the credentials, and issues the SQL calls under that account.

According to some embodiments, tenant operator 218 also assigns one or more user accounts with privileges to assign artifacts to a tenant created within database instance 212. Users may log into application 230 using those user accounts and issue calls directly (i.e., without using tenant management service 216 or tenant operator 218) to database instance 212 to assign such artifacts to a tenant.

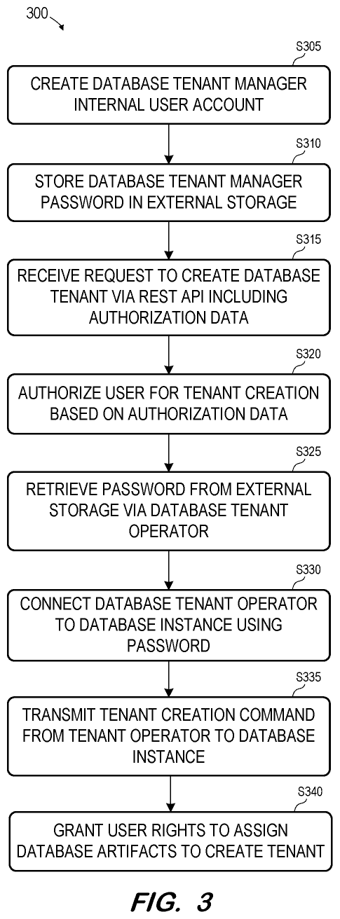

FIG. 3 comprises a flow diagram of process 300 to provide tenant lifecycle management operations according to some embodiments. Process 300 and all other processes mentioned herein may be embodied in program code executable by one or more processing units (e.g., processor, processor core, processor thread) and read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, a tenant manager user account is created on a database instance at S305. According to some embodiments, the tenant manager user account is an internal account (i.e., only usable by components of the database platform) which may issue SQL calls to the database instance for performing tenant lifecycle operations. The tenant manager user account may be created by a database service operator component of the platform. The database service operator component may store credentials (e.g., username and password) of the tenant manager user account to a storage external to the database platform (e.g., a cloud-based secure storage, Vault by HashiCorp) at S310.

At S315, a request to create a database tenant is received. The request is received via a REST API and includes authorization data of the user who initiated the API call, for example by issuing a tenant creation instruction to a multi-tenant application. The user S320 is authorized for tenant creation based on the authorization data, using any suitable authentication and authorization mechanism.

Next, at S325, a database tenant operator of the database platform retrieves the password of the tenant manager user account from the vault at S325. The database tenant operator connects to the database instance using the username and password of the tenant manager user account at S330, and, at S335, transmits an SQL statement requesting tenant creation to the database instance. The database instance creates a tenant (i.e., instantiates an instance of a tenant object) based on the received statement.

At S340, the tenant operator may issue a further SQL statement to grant the user from whom the request was received at S315 rights to assign database artifacts to the created tenant. Accordingly, the user may thereafter initiate SQL calls to the database instance under the user's own credentials to assign the artifacts to the tenant.

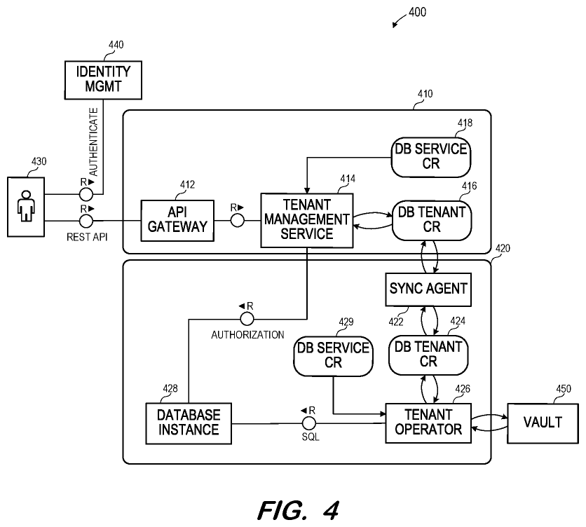

FIG. 4 illustrates an implementation of process 300 according to some embodiments. Architecture 400 includes orchestration cluster 410 and database-as-a-service cluster 420. As is known in the art, each of clusters 410 and cluster 420 may include one or more nodes implementing software containers for executing containerized applications. The containers of cluster 420 may execute applications to be provided as a service to third parties while the containers of orchestration cluster 410 may execute applications for building and managing the containerized applications within 420.

According to some embodiments, clusters 410 and 420 conform to the Kubernetes container orchestration system. Clusters 410 and 420 may execute software extensions, or operators, to manage associated applications and their components based on custom resources. In some instances, an operator watches for creation/update/deletion of custom resources and executes responsive actions using applications corresponding to the custom resources. Such watching and execution may be implemented using components 416, 422, 424 and 426, which are not present in more generic architecture 200.

For example, in a case that a request to create a database tenant is received by API gateway 412 and passed to tenant management service 412, tenant management service 412 translates the request into custom resources which tenant operator 426 will reconcile by issuing commands to create a database tenant within database instance 428. In particular, tenant management service 412 creates a new database tenant custom resource within database tenant custom resources 416 of orchestration cluster 410.

The database tenant custom resource 416 may be deployed in cluster 410 as a first-class citizen at the same level as database instance custom resource 418, which is used to orchestrate creation/update/deletion of database instances. The following is an example of a database tenant custom resource 416 according to some embodiments:

```
kind: DBTenant
metadata:
  name: <tenant_instance_guid> // e.g.
  c247c0c3-50d3-4a47-a6c2-eba317d92238
  labels:
    globalaccount_id: ggg
    subaccount_id: zzz
    service_instance_id: yyy
  spec:
    name: xxx
    assigner: <tenant assigner>
    serviceInstanceID: yyy
status:
  endpoints:
    sql: “xxxxxx.ondemand.sap.com:443”
  conditions:
  - lastProbeTime: “1970-01-01T00:00:00Z”
    lastTransitionTime: “2021-10-08T01:33:45Z”
    reason: DBServiceNotFound|AssignerNotFound|...
    status: “True|False|Unknown”
    type: Ready
```

tenant_instance_guid is a GUID that uniquely identify a tenant across all landscapes. Its value may be generated by tenant management service 414. The specified SQL endpoint is the endpoint of the database instance in which the tenant resides or should be created. In some embodiments, the custom resources of each tenant within a database instance specify the same SQL endpoint.

As illustrated in FIG. 4, sync agent 422 of orchestration cluster 420 monitors database tenant custom resource 416 for changes and synchronizes any such changes to database tenant custom resource 424 of database cluster 420. Tenant operator 426 reacts to changes to database tenant custom resource 424 in order to reconcile the changed database tenant custom resource 424 with the service instance specified in the custom resource (i.e., database instance 428).

For example, if the database tenant custom resource 424 describes a tenant within database instance 428 and the tenant does not in fact exist within database instance 428, operator 426 initiates the steps described above with respect to S325 through S340 of process 300 to create the tenant. Similarly, if a particular tenant exists within database instance 428 but the changed custom resource 424 does not associated that tenant with database instance 428, tenant operator 426 issues SQL commands to database instance to delete the tenant.

Cluster 420 also includes a sync agent (not shown) to synchronize database service custom resource 418 with database service custom resource 429. A service operator (not shown) within cluster 420 reacts to changes to database service custom resource 429 to ensure that the database instances executing within platform 420 conform thereto.

Prior to tenant creation/update/deletion as described above, tenant operator 426 may access database service custom resource 429 to determine whether any database instance-level operations such as recovery or upgrade are ongoing. If so, tenant operator 426 waits until completion of the ongoing operation until proceeding with tenant creation/update/deletion. Tenant operator 426 may also determine based on database service custom resource 429 that a database instance is to be deleted. in some embodiments, tenant operator 426 responds by writing a flag to database service custom resource 429 and removing the flag after deleting all tenants from the database instance.

As mentioned above, some embodiments separate privileges for creating/dropping tenants from privileges for assigning objects to a tenant for security reasons. Tenant create/drop privileges are given only to a specific internal user account (e.g., _TENANT_MANAGER) which is used by tenant operator 426. A user account which provides mapping of artifacts to a tenant may be referred to as a tenant assigner.

Architecture 400 provides mechanisms for separating and authorizing both of the above user accounts. For example, customer 430 (or, more particularly, a service broker in communication with a multi-tenant application operated by customer 430) authenticates against identity management component and receives a JSON Web Token in return. The JWT may be encrypted with a private key specific to platform 420.

The REST API request sent to API gateway 412 to create/update/delete a tenant includes the JWT. API gateway 412 may validate the JWT using a public key associated with platform 412. The request is forwarded to tenant management service 414, which connects to database instance 428 using the JWT. Database instance 428 returns a user corresponding to the JWT. Accordingly, after creation/update/deletion of the tenant based on the request, tenant operator 426 issues an SQL command to database instance 428 to grant tenant assigner rights to the user.

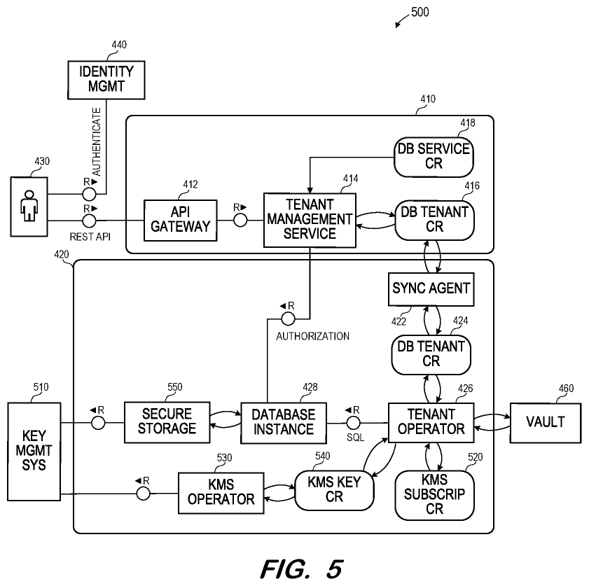

Architecture 500 of FIG. 5 adds several components to architecture 400 to support customer-controlled encryption keys. A customer-controlled encryption key is used in the encryption of tenant data which is stored “at-rest” in a persistent storage of database instance 420.

More particularly, the at-rest data associated with a tenant of database instance 428 of architectures 400 and 500 is encrypted using a tenant-specific data encryption key which is persisted in platform 420. However, in architecture 500, the tenant-specific data encryption key itself is encrypted by a customer-controlled encryption key prior to being persisted in platform 420. Accordingly, database instance 428 of platform 420 must request decryption of the tenant-specific data encryption key using the customer-controlled encryption key prior to decrypting persisted tenant data. If the customer-controlled encryption key is revoked by the client or otherwise inaccessible, the tenant-specific data encryption key cannot be decrypted and, in turn, the persisted tenant data also cannot be decrypted.

Architecture 500 includes key management system (KMS) 510 which may be directly accessible to customers. KMS 510 may securely store tenant-specific encryption keys which may be stored therein, disabled, and deleted therefrom by respective customers.

The tenant management REST API used in architecture 500 may allow specification of an encryption configuration and a subscription context. The encryption configuration indicates a type of customer-controlled encryption key to be used and the subscription context includes information needed to create an encryption key in a KMS of the customer. Accordingly, database tenant custom resource 416 of architecture 500 includes fields for storing an encryption configuration and a subscription context. The fields may be added under annotations; and spec: as shown in the example below:

```
metadata:
  annotations:
      btp.sap.com/subscriptionContext: |-
        {
          “globalAccountID”: “”,
          “subAccountID”: “”,
          “applicationName”: “”,
          “keyConsumerName”: “”,
          “crmCustomerID”: “”
        }
    spec:
      dataEncryption:
        mode: DEDICATED_KEY|MANAGED_KEY
        keyID: key-123
```

Database tenant custom resource 424 is synchronized with updated values of database tenant custom resource 416 as described above. Tenant operator 426 passes the dataEncryption and subscriptionContext values to KMS subscription custom resource 520. KMS 530 monitors KMS subscription custom resource 520 and, in response to a new KMS subscription custom resource 520, requests a subscription from KMS 510. In response, KMS 510 will create an encryption key and a technical user. KMS operator 530 receives credentials of the user and a dynamic reference to the encryption key from KMS 510.

KMS operator 530 writes the user credentials to a path of vault 460, and writes the KMS endpoint, the vault path, a key id, and the dynamic key reference to KMS key custom resource 540. Tenant operator 426 retrieves this information from KMS key custom resource 540 and creates a tenant in database instance 428 via SQL using the information of database tenant custom resource 424 as describe above and also using the customer key information specified in KMS key custom resource 540.

Creation of the tenant includes building of a configuration for secure storage 550 based on the customer key information specified in KMS key custom resource 540. The configuration allows secure storage 550 to access the vault path of vault 450 to retrieve the credentials for KMS 510 stored therein, and to use the credentials to request KMS 510 to decrypt a data encryption key specific to the current tenant using the dynamically-referenced encryption key. Secure storage 550 may therefore be assigned a service account for vault 450 to be used for accessing credentials of KMS 510 for all tenants of database instance 428.

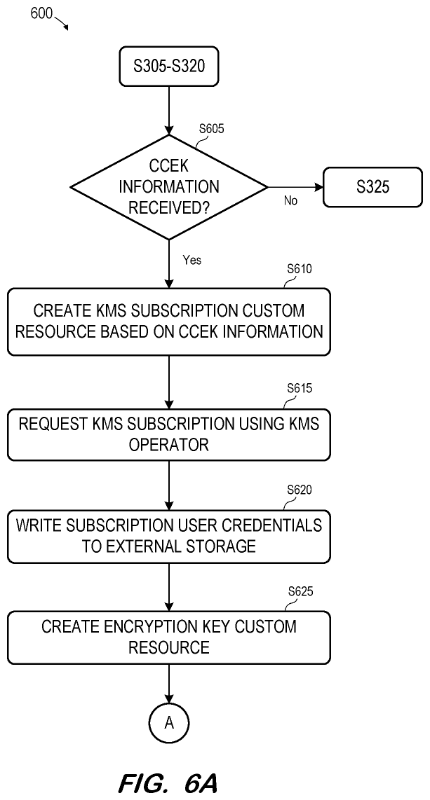

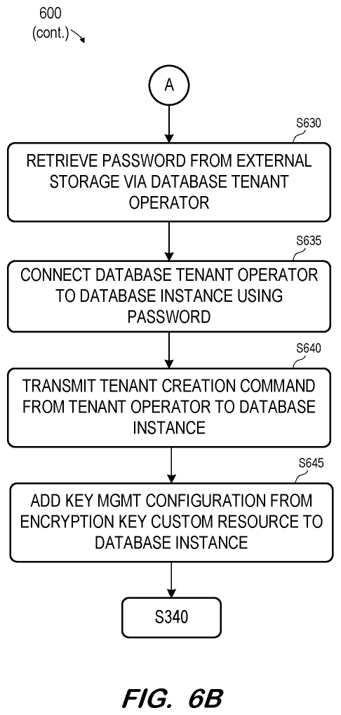

Process 600 of FIGS. 6A and 6B includes steps performed by the components of architecture 500 to perform a database tenant lifecycle operation according to some embodiments. As shown, process 600 begins with S305 through S320 as described above with respect to process 300. At S605, it is determined whether the received REST API call includes information associated with a customer-controlled encryption key such as, but not limited to, an encryption configuration and a subscription context. If not, flow proceeds to S325 of process 300 and continues as described above.

Flow proceeds to S610 if the determination at S605 is affirmative. At S610, a KMS subscription custom resource is created based on subscription information (e.g., a subscription context) included in the customer-controlled encryption key-associated information. In response to this KMS subscription custom resource, a KMS operator requests a subscription from a KMS based on the subscription information at S615. The KMS operator then receives user credentials and a dynamic reference to the subscribed-to encryption key from the KMS.

The user credentials are written to external storage at S620. At S625, an encryption key custom resource is created including the KMS endpoint, the path of the external storage at which the credentials are stored, and the dynamic key reference received from the KMS.

As described with respect to S325 and S330, a database tenant operator retrieves the tenant manager user password from the external storage and connects to the database instance using the password at S630 and S635. Moreover, at S640, a tenant creation command is transmitted from the tenant operator to the database instance as described with respect to S330. At S645, the tenant operator uses the encryption key custom resource to add a key management configuration to the database instance via SQL. The key management configuration allows the database instance to access the path of the external storage to retrieve the credentials stored therein, and to use the credentials to request the KMS to decrypt a data encryption key specific to the current tenant using the dynamically-referenced encryption key. Flow then proceeds to S340 as described above.

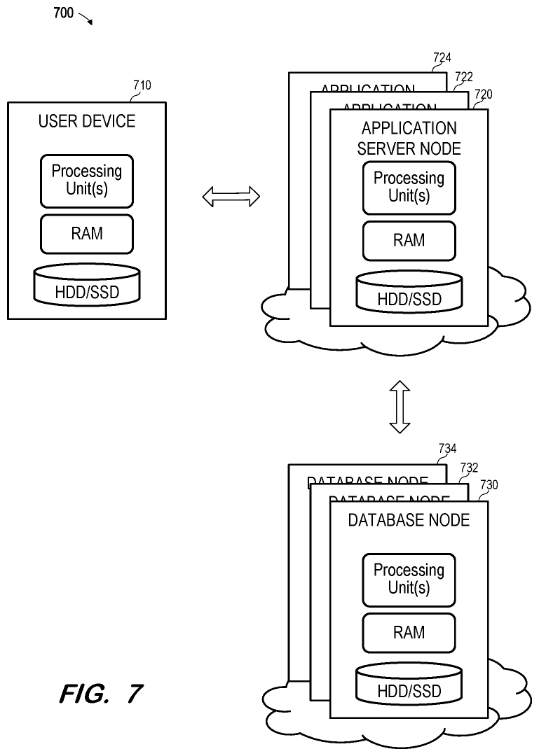

FIG. 7 illustrates cloud-based database deployment 700 according to some embodiments. User device 710 may comprise any suitable computing system operable by a user to access a cloud-based application. User device 710 may store and execute program code of a Web browser to access a Uniform Resource Locator (URL) associated with a login page of such an application. The Web browser may download and execute program code of a client-side component of an application as is known in the art.

Application server nodes 720, 722 and 724 may host an application according to some embodiments. The application may comprise a multi-tenant application and server nodes 720, 722 and 724 may be geographically distributed. Server nodes 720, 722 and 724 may comprise nodes of one or more Kubernetes clusters.

Database nodes 730, 732 and 734 may host one or more database instances accessible to the multi-tenant application and providing native multi-tenancy as described herein. Database nodes 730, 732 and 734 may comprise nodes of an orchestration cluster an/or a database cluster as is known in the art. Each node of deployment 700 may comprise a separate physical machine or a virtual machine. Such virtual machines may be allocated by a cloud provider providing self-service and immediate provisioning, autoscaling, security, compliance and identity management features.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A computer-implemented method comprising:
receiving a call to an application programming interface, the call comprising a request to create a database tenant in a database instance executing on a database platform;
determining, at an operator executing on the database platform, to create the tenant based on the received call;
in response to the determination, retrieving by the operator of credentials of a tenant manager user from a storage external to the database platform;
connecting the operator to the database instance using the credentials; and
transmitting, from the operator to the database instance, a Structured Query Language command to create the tenant.

2. A computer-implemented method according to claim 1, further comprising:
based on the received call, creating a database tenant custom resource associated with the tenant,
wherein determining to create the tenant comprises:
synchronizing the database tenant custom resource to the database platform; and
identifying, by the operator, of the synchronized database tenant custom resource of the database platform.

3. A computer-implemented method according to claim 2, wherein the call includes authorization information, the method further comprising:
presenting the authorization information to the database instance;
receiving a user from the database instance in response to the authorization information; and
transmitting, from the operator to the database instance, a second Structured Query Language command to assign the user a right to assign artifacts to the tenant.

4. A computer-implemented method according to claim 2, further comprising:
requesting, by a second operator executing on the database platform, a customer-controlled encryption key from a key management system external to the database platform;
receiving, in response to the request, key management system credentials and a key identifier;
storing, by the second operator, the key management system credentials in the storage external to the database platform; and
transmitting, from the operator to the database instance, a second Structured Query Language command to create a configuration for use by the database instance to retrieve the key management system credentials from the external storage and use the key management system credentials to request decryption using the customer-controlled encryption key.

5. A computer-implemented method according to claim 1, wherein the call includes authorization information, the method further comprising:
presenting the authorization information to the database instance;
receiving a user from the database instance in response to the authorization information; and
transmitting, from the operator to the database instance, a second Structured Query Language command to assign the user a right to assign artifacts to the tenant.

6. A computer-implemented method according to claim 1, further comprising:
requesting, by a second operator executing on the database platform, a customer-controlled encryption key from a key management system external to the database platform;
receiving, in response to the request, key management system credentials and a key identifier;
storing, by the second operator, the key management system credentials in the storage external to the database platform; and
transmitting, from the operator to the database instance, a second Structured Query Language command to create a configuration for use by the database instance to retrieve the key management system credentials from the external storage and use the key management system credentials to request decryption using the customer-controlled encryption key.

7. A system comprising:
a database platform comprising:
a memory storing executable program code; and
at least one processing unit to execute the program code to cause the database platform to:
receive a call to an application programming interface, the call comprising a request to create a database tenant in a database instance executing on the database platform;
determine, at an operator executing on the database platform, to create the tenant based on the received call;
in response to the determination, retrieve by the operator of credentials of a tenant manager user from a storage external to the database platform;
connect the operator to the database instance using the credentials;
transmit, from the operator to the database instance, a Structured Query Language command to create the tenant; and
in response to the command, create the tenant in the database instance.

8. A system according to claim 7, the at least one processing unit to execute the program code to cause the database platform to:
based on the received call, create a database tenant custom resource associated with the tenant,
wherein determination to create the tenant comprises:
synchronize the database tenant custom resource to the database platform; and
identify, by the operator, the synchronized database tenant custom resource of the database platform.

9. A system according to claim 7, wherein the call includes authorization information, the at least one processing unit to execute the program code to cause the database platform to:
present the authorization information to the database instance;
receive a user from the database instance in response to the authorization information; and
transmit, from the operator to the database instance, a second Structured Query Language command to assign the user a right to assign artifacts to the tenant.

10. A system according to claim 8, the at least one processing unit to execute the program code to cause the database platform to:
request, by a second operator executing on the database platform, a customer-controlled encryption key from a key management system external to the database platform;
receive, in response to the request, key management system credentials and a key identifier;
store, by the second operator, the key management system credentials in the storage external to the database platform; and
transmit, from the operator to the database instance, a second Structured Query Language command to create a configuration for use by the database instance to retrieve the key management system credentials from the external storage and use the key management system credentials to request decryption using the customer-controlled encryption key.

11. A system according to claim 7, wherein the call includes authorization information, the at least one processing unit to execute the program code to cause the database platform to:
present the authorization information to the database instance;
receive a user from the database instance in response to the authorization information; and
transmit, from the operator to the database instance, a second Structured Query Language command to assign the user a right to assign artifacts to the tenant.

12. A system according to claim 7, the at least one processing unit to execute the program code to cause the database platform to:
request, by a second operator executing on the database platform, a customer-controlled encryption key from a key management system external to the database platform;
receive, in response to the request, key management system credentials and a key identifier;
store, by the second operator, the key management system credentials in the storage external to the database platform; and
transmit, from the operator to the database instance, a second Structured Query Language command to create a configuration for use by the database instance to retrieve the key management system credentials from the external storage and use the key management system credentials to request decryption using the customer-controlled encryption key.

13. A non-transitory computer-readable medium storing executable program code, the program code executable to cause a system to:
receive a call to an application programming interface, the call comprising a request to create a database tenant in a database instance executing on a database platform;
determine, at an operator executing on the database platform, to create the tenant based on the received call;
in response to the determination, retrieve by the operator of credentials of a tenant manager user from a storage external to the database platform;
connect the operator to the database instance using the credentials;
transmit, from the operator to the database instance, a Structured Query Language command to create the tenant; and
in response to the command, create the tenant in the database instance.

14. A medium according to claim 13, the program code executable to cause a system to:
based on the received call, create a database tenant custom resource associated with the tenant,
wherein determination to create the tenant comprises:
synchronize the database tenant custom resource to the database platform; and
identify, by the operator, the synchronized database tenant custom resource of the database platform.

15. A medium according to claim 13, wherein the call includes authorization information, the program code executable to cause a system to:
present the authorization information to the database instance;
receive a user from the database instance in response to the authorization information; and
transmit, from the operator to the database instance, a second Structured Query Language command to assign the user a right to assign artifacts to the tenant.

16. A medium according to claim 14, the program code executable to cause a system to:
request, by a second operator executing on the database platform, a customer-controlled encryption key from a key management system external to the database platform;
receive, in response to the request, key management system credentials and a key identifier;
store, by the second operator, the key management system credentials in the storage external to the database platform; and
transmit, from the operator to the database instance, a second Structured Query Language command to create a configuration for use by the database instance to retrieve the key management system credentials from the external storage and use the key management system credentials to request decryption using the customer-controlled encryption key.

17. A medium according to claim 13, wherein the call includes authorization information, the program code executable to cause a system to:
present the authorization information to the database instance;
receive a user from the database instance in response to the authorization information; and
transmit, from the operator to the database instance, a second Structured Query Language command to assign the user a right to assign artifacts to the tenant.

18. A medium according to claim 13, the program code executable to cause a system to:
request, by a second operator executing on the database platform, a customer-controlled encryption key from a key management system external to the database platform;
receive, in response to the request, key management system credentials and a key identifier;
store, by the second operator, the key management system credentials in the storage external to the database platform; and
transmit, from the operator to the database instance, a second Structured Query Language command to create a configuration for use by the database instance to retrieve the key management system credentials from the external storage and use the key management system credentials to request decryption using the customer-controlled encryption key.
